(19) United States
(12) Patent Application Publication
(10) Pub. No.: US 2005/0126837 A1
(43) Pub. Date: Jun. 16, 2005

(54) Pressurized fuel vehicle having fuel system with an air motor

(76) Inventor: Morse N. Taxon, Oak Park, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 10/733,670

(22) Filed: Dec. 11, 2003

(51) Int. Cl. B60K 6/00

(52) U.S. Cl. 180/65.2; 180/69.4

(57) ABSTRACT

A vehicle using pressurized fuel having a fuel tank, an engine, and an electrical system, the vehicle comprising: an air motor/generator operatively connected to the electrical propulsion system where the air motor/generator is configured to generate energy stored in the pressurized fuel. This electricity is utilized directly by the electrical system (or electrical propulsion system in HEV's) or it can be stored in the battery or battery pack.

### FIELD OF THE INVENTION

The present invention relates generally to vehicles that employ pressurized fuel such as propane, natural gas, or hydrogen. More particularly, the present invention relates to a hybrid electric vehicle and other vehicles using pressurized fuel that have a fuel system having an integrated air motor configured to increase overall efficiency of the vehicle by capturing some of the potential energy stored in pressurized fuel, permitting complete utilization of such fuel, and permitting the use of fuel that is available at less than optimal pressure.

### BACKGROUND OF THE INVENTION

The use of hydrogen and other gaseous fuels for vehicles is not new. For example, compressed natural gas (CNG) has occasionally been used as the fuel for internal combustion powered fleet vehicles in markets where CNG represented a low cost, low emission, and relatively high octane fuel source.

The allure of hydrogen as a fuel flows from the most basic of chemical formulae: hydrogen plus oxygen equals water. This formula suggests that many of our vehicle related air quality problems could be eliminated simply by fueling future vehicles with hydrogen gas whether they are powered by conventional internal combustion engines, fuel cells, or hybrid fuel cell battery systems.

Hybrid electric vehicles (HEV's) that use both a gasoline, or a compressed fuel such as CNG or hydrogen, and an electric motor are an ideal way to take advantage of the best qualities of combustion engines and electric powered vehicles. Generally, hybrids are configured so that an engine powers the wheels directly, and/or powers a generator to produce electricity that powers the electric motor directly or is stored in the batteries. The engine, the electric motor, and the batteries can all be downsized resulting in a significant weight reduction. Depending on the desired vehicle performance, efficiency, etc, the gasoline and electric engines may be sized and configured to run singly or together depending on a number of factors. Such hybrid vehicles and their control strategies are disclosed in U.S. Pat. Nos. 6,540,035 B2, and 6,491,120 B1, the contents of which are specifically incorporated by reference herein.

A newer type of hybrid vehicle combines a high efficiency fuel cell with an electric motor and a battery pack. Fuel cell hybrids essentially provide two sources of electricity for a main drive electric motor: the fuel cell stack and electricity stored in the batteries. Fuel cell hybrids have a number of advantages over gasoline hybrids such as very few moving parts and significantly reduced or no emissions. Fuel cell hybrids are discussed in U.S. Pat. No. 6,580,977 B2, for example, the contents of which are specifically incorporated by reference herein. Some consider them superior to gasoline hybrids. Fuel cell hybrids, like internal combustion hybrids, are designed so that the battery pack is recharged as the vehicle operates (using current generated from operation of the fuel cell and/or current generated via braking, etc.), thus eliminating the need to “plug in” the battery to recharge it.

Regardless of the type of vehicle, it is very desirable to use a pressurized fuel as the energy source because such fuels have the potential to burn cleanly and efficiently. Hydrogen is particularly attractive as mentioned, above. Also attractive, and more available at the moment, are propane and natural gas (stored as CNG—compressed natural gas).

A particular problem of all pressurized fuels is that that their volumetric energy density is rather poor. This problem is overcome to some extent by significantly compressing or pressurizing the chosen fuel. Such compression takes energy that is generally not considered when calculating the energy value of the compressed fuel. Further, this energy is lost when the fuel is depressurized (typically in an expansion chamber) to the desired pressure for use in the vehicle engine or fuel cell.

### SUMMARY OF THE INVENTION

One object of the present invention is a vehicle that captures the potential energy stored in pressurized fuel.

Another object of the invention is a vehicle having increased overall efficiency by making better use of its fuel and permitting use of the highest pressure fuel the vehicle fuel tank is designed for.

These and other objects of the invention are satisfied by a vehicle using pressurized fuel having a fuel tank, an engine, and an electrical system, the vehicle comprising: an air motor/generator operatively connected to the electrical propulsion system where the air motor/generator converts the compression energy in the stored fuel into electricity.” This electricity is utilized directly by the electrical system (or electrical propulsion system in HEV's) or it can be stored in the battery or battery pack.

### BRIEF DESCRIPTION OF THE DRAWINGS

FIG. 1 is a schematic view of a recovery system according to the present invention.

FIG. 2 is a schematic view of the recovery system according to the present invention operated in reverse to store fuel in the vehicle's tank at an increased pressure.

### DESCRIPTION OF THE INVENTION

The use of pressurized fuels is not new. Many such as CNG and propane have been used for small scale fleets. These uses have been driven by price, availability, power, and clean burning characteristics of such fuels. In the past, however, the use of pressurized fuels has typically been limited to larger vehicles, such as trucks, due in part to the relatively large size of the fuel tanks necessary to provide fuel to power the vehicle over an acceptable range. (Such tanks are described in U.S. Pat. No. 5,810,309 (mounting assembly for retrofitting a CNG tank to an existing vehicle by cutting part of the frame); U.S. Pat. No. 6,042,071 (mounting assembly for a large CNG tank that takes over the trunk compartment and accommodates expansion and contraction of the tank); and U.S. Pat. No. 6,536,722 (rack for mounting a number of CNG tanks such as on a bus).) Currently, pressurized fuel, particularly hydrogen, is being evaluated for use in hybrid vehicles that combine either an internal combustion engine or a fuel cell with batteries as discussed above.

In order to maximize efficiency in hybrid vehicles, using either an internal combustion engine or a fuel cell, it is advantageous to take into consideration the energy required to compress the fuel that these vehicles use. For example, a tank of pressurized fuel at 5000 psi (350 bar), 10,000 psi (700 bar), or greater contains stored energy beyond the heating value of the fuel. The object of the present invention is to add to the overall efficiency of the vehicle by capturing some of this energy via an “air motor” driven by the decompressing fuel coupled to a generator to produce electricity. As used herein, the term “air motor” is specifically defined to mean any positive displacement device, for example but not limited to roots, vanes, scroll types, diaphragm pumps, etc. either alone or in combination with others. Some air motors are specifically described in U.S. Pat. Nos. 4,185,465 (helical screw expander induction generator), 5,192,199 (rotary screw type generator), 5,247,795 (scroll type expander), and 6,460,350 (turboexpander driver), the contents of which are specifically incorporated herein by reference. As used herein, the term “air motor/generator” refers to an air motor operatively coupled to a generator.

The electricity generated via decompressing the fuel can be used directly to power vehicle component that use electricity (lights, fan(s), heating element(s), etc.), power the electric drive motor(s) in an HEV, or be stored in the vehicle's battery or battery pack (in an HEV) for use as needed at a later time. In addition, the generated energy can be used to power a more complete emptying of the fuel storage tank. Since an HEV's fueled engine or fuel cell must produce all the electricity used by the vehicle, any electricity generated via the decompressing fuel ultimately lowers the load on the engine or fuel cell and increases the vehicle's overall efficiency. In particular, there is some interest now in using small fuel cells as Auxiliary Power Units (APUs) to replace alternators altogether. If such a fuel cell is powered by compressed gas, this system could help to reduce the necessary capacity of the APU.

As higher pressure tanks become available (i.e. greater than 10,000 psi, such as a 20,000 psi tank) any vehicle equipped with the energy recapture system described herein can make full use of the storage capacity of such tanks regardless of the pressure of the available fuel. For this application of the invention the various components are operated in reverse: the generator is powered by the battery or directly off the engine or fuel cell as a motor connected to the air motor. The air motor is thus operated as a powered compressor that draws the fuel and pressurizes it up to the desired temperature in the vehicle high pressure tank.

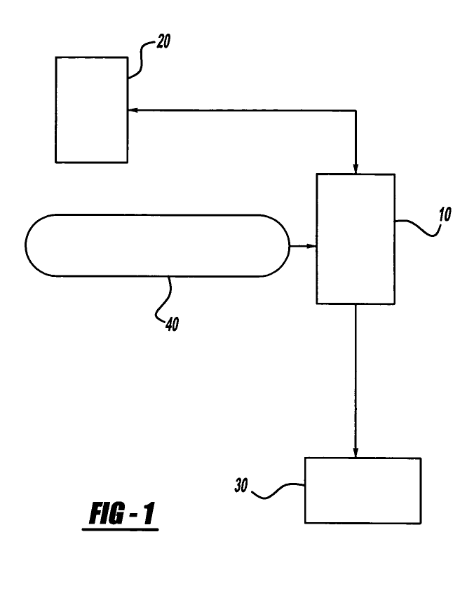

In the Figures, like numbers refer to like components. FIG. 1 is a schematic illustration of the energy recapture system of the invention. An air motor/generator 10 is operatively connected to the pressurized fuel tank 40. The air motor/generator 10 is operatively connected to the electrical system 20. As used herein, the term “electrical system” is specifically intended to include the battery and all the components connected to operate off the vehicle's electrical system (lights, accessories, etc.) and additionally in an HEV and to the electric drive motor(s), battery pack, etc. As used herein, the term “electrical propulsion system” specifically refers to the electrical system in an HEV as well as the electric drive motor(s), battery pack, etc.

In the present invention, pressurized fuel from the high pressure storage tank 40 is directed toward the air motor/generator 10 where the potential energy resulting from its initial pressurization is used to turn the air motor/generator 10 to generate electricity. The generated electricity can then be stored in the battery or battery pack 20 or used immediately to drive electrically powered vehicle components 30 or accessories 30, or in an HEV, to run the drive motor(s) 30.

As the amount of fuel in the tank 40 begins to be exhausted, power from the battery back 20 is used to run the generator as a motor such that the air motor is powered as a pump to draw off the diminishing quantities of fuel from the vehicle fuel tank 40 and pressurize this remaining fuel up to the operating pressure of the engine/fuel cell 30, prior to directing this fuel to the engine/fuel cell 30.

The efficacy of this operation is clarified by the following example. Suppose the tank is at 5000 psi, and the engine requires 500 psi. Once enough gaseous fuel is used to lower that tank pressure to less than 500 psi, it can no longer provide what the engine needs. Unfortunately, this means that about 10% of the fuel in the tank would be unusable. With the present invention, however, instead of the air motor turning the generator, the generator is electrically driven as a motor, and drives the air motor as a pump. This pump can pressurize the gas remaining in the tank up to the 500 psi required by the engine, and thus can fully empty the tank, using that last 10%, to increase vehicle range.

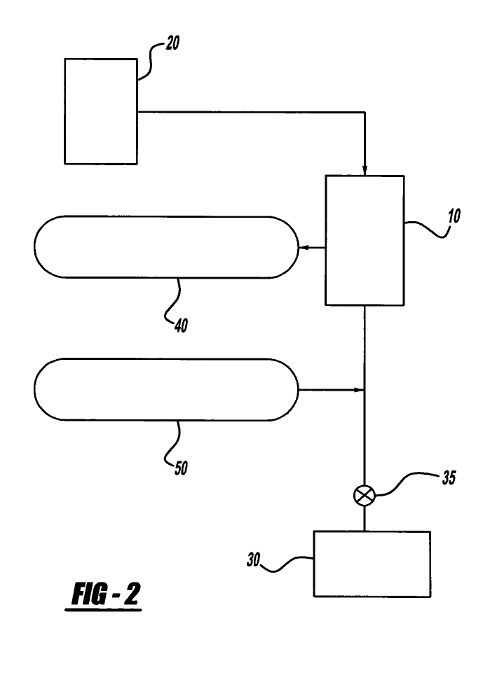

FIG. 2 illustrates the operation of the invention to pressurize fuel to the maximum optimum pressure of the storage tank 40, effectively resolving an impediment to the use of higher pressure vehicle tanks. By providing appropriate switching and valves, such as a valve 35 to the engine or fuel cell 30, fuel from a storage tank 50, stored at a pressure less than the maximum allowable pressure for the vehicle tank 40, is connected to and flows through the air motor/generator 10. Power from the battery pack 20 is used to run the generator as an engine such that the air motor compresses the fuel from the storage tank 50 into the vehicle fuel tank 40 until the fuel in the fuel tank 40 is at the fuel tank 40's maximum pressure.

Operation of the air motor/generator 10 and coordination along with appropriate valving and switches (not shown) are preferably controlled by the vehicle processing unit. This permits the optimization of the invention to achieve a variety of different goals. For example, it might be optimal to operate and integrate the engine/generator 30 with the goal of achieving maximum overall vehicle efficiency. Or it might be optimal to operate and integrate the engine/generator with the goal of achieving maximum fuel utilization. Or it might be optimal to operate and integrate the engine/generator 10 to achieve maximum vehicle range. One skilled in the art will understand from the above description that by resetting operational characteristics the present invention permits achieving a variety of operational objectives.

Although the invention has been described with reference to specific embodiments thereof, the forms of the invention shown and described are a non-limiting embodiment and various changes and modifications, such as described herein as well those that are obvious to those skilled in the art, may be made without departing from the spirit and scope of the invention as defined in the claims below.

1. A vehicle using pressurized fuel having a fuel tank, an engine, and an electrical system, said vehicle comprising:
an air motor/generator operatively connected to said electrical system.

2. The vehicle of claim 1, where said air motor comprises a rotary screw.

3. The vehicle of claim 1, where said air motor/generator is configured and operationally connected to
depressurize said fuel from said fuel tank for said engine; and simultaneously generate electricity for said electrical system.

4. The vehicle of claim 1, where said air motor/generator is configured and operationally connected to
pressurize fuel from said fuel tank for said engine; by simultaneously drawing electricity from said electrical system.

5. A hybrid vehicle using pressurized fuel having a fuel tank, an engine, and an electrical system, said hybrid vehicle comprising:
an air motor/generator operatively connected to said electrical system.

6. The hybrid vehicle of claim 5, where said air motor comprises a rotary screw.

7. The hybrid vehicle of claim 5, where said air motor/generator is configured and operationally connected to
depressurize said fuel from said fuel tank for said engine; and simultaneously generate electricity for said electrical propulsion system.

8. The hybrid vehicle of claim 5, where said air motor/generator is configured and operationally connected to
pressurize fuel from said fuel tank for said engine; by simultaneously drawing electricity from said electrical system.

9. A hybrid vehicle using pressurized fuel having a fuel tank, a fuel cell, an electric motor, and a battery pack, said hybrid vehicle comprising:
an air motor/generator operatively connected to said electric motor and said battery pack.

10. The hybrid vehicle of claim 9, where said air motor comprises a rotary screw.

11. The hybrid vehicle of claim 9, where said air motor/generator is configured and operationally connected to
depressurize said fuel from said fuel tank for said fuel cell; and simultaneously generate electricity for said electric motor, or said battery pack, or both said electric motor and said battery pack.

12. The hybrid vehicle of claim 9, where said air motor/generator is configured and operationally connected to
pressurize fuel from said fuel tank for said fuel cell; by simultaneously drawing electricity from said battery pack.
